(19) United States
(12) Patent Application Publication
(10) Pub. No.: US 2023/0072542 A1
(43) Pub. Date: Mar. 9, 2023

(54) COMPRESSOR FOR VEHICLE

(71) Applicants: Hyundai Motor Company, Seoul (KR); Kia Corporation, Seoul (KR)

(72) Inventors: Man Ju OH, Yongin-Si (KR); Uk II YANG, Yongin-Si (KR)

(73) Assignees: Hyundai Motor Company, Seoul (KR); Kia Corporation, Seoul (KR)

(21) Appl. No.: 17/738,623

(22) Filed: May 6, 2022

(30) Foreign Application Priority Data
Sep. 3, 2021 (KR) 10-1021-0117791

(51) Int. Cl. B60H 1/32; F25B 30/02

(52) U.S. Cl. CPC B60H 1/32281; F25B 30/02

(57) ABSTRACT

A compressor apparatus for a vehicle is configured to compress and then heat refrigerant used in a heat pump system. A compression portion compresses refrigerant. A heating portion is provided integrally with the compression portion. An internal space in which the refrigerant discharged from the compression portion flows is defined in the heating portion. The heating portion heats and discharges the refrigerant flowing in the internal space.

### CROSS REFERENCE TO RELATED APPLICATION

The present application claims priority to Korean Patent Application No. 10-2021-0117791, filed Sep. 3, 2021, the entire contents of which is incorporated herein for all purposes by this reference.

### BACKGROUND OF THE PRESENT DISCLOSURE

### Field of the Present Disclosure

The present disclosure generally relates to a compressor apparatus for a vehicle, and more particularly, to a compressor apparatus for a vehicle configured to compress and then heat refrigerant used in a heat pump system.

### DESCRIPTION OF RELATED ART

Recently, due to environmental issues of internal combustion engine (ICE) vehicles, the distribution of eco-friendly vehicles, such as electric vehicles, is increasing. However, in conventional ICE vehicles, additional energy for heating has not been required, because the interior thereof may be heated using waste heat of the engine. However, eco-friendly vehicles, such as electric vehicles, should perform heating using separate energy, because there is no heat source, such as an engine. Thus, there has been a problem in that fuel efficiency is reduced.

Furthermore, due to the problem of electric vehicles, such as reduced fuel efficiency, the driving range of electric vehicles may be reduced, causing electric vehicles to be frequently charged, which is problematic.

Thus, air conditioning systems of eco-friendly vehicles, such as an electric vehicle, use a heat pump system different from that of air conditioning systems of ICE vehicles.

In general, the heat pump system is a cooling/heating device that moves heat from a low-temperature heat source to a high-temperature environment or from a high-temperature heat source to a low-temperature environment using heat generated by refrigerant or condensation heat of refrigerant. During heating, the heat pump system absorbs heat from the outside thereof and dissipates the heat to the interior. During cooling, the heat pump system dissipates heat from the interior to the outside.

However, in eco-friendly vehicles, such as an electric vehicle, heat management requirements for electric parts, such as the battery and the motor, have been added, in addition to the air-conditioning system.

That is, the interior, the battery, and the electric parts used in an eco-friendly vehicle, such as an electric vehicle, have different needs for air conditioning. A technology for minimizing the use of energy by independently responding to such needs by efficient cooperation is required. Thus, there has been proposed an integrated heat management concept for vehicles intended to increase heat efficiency by integrating overall heat management operations of each vehicle while independently performing heat management operations for respective components.

For such integrated heat management for a vehicle to be performed, it is necessary to integrate complicated cooling water lines, refrigerant lines, and parts into a module. There has been demanded a novel concept for converting a plurality of parts into a module, which is easy to fabricate and may be compactly packaged.

Meanwhile, an integrated heat management system of a vehicle using a heat pump system includes a water-heating heater provided on a cooling water line to increase the temperature of a battery, in preparation for a case in which the heat pump system does not properly operate as in a case in which the ambient air has low temperature. Furthermore, an air-heating heater for heating the internal space is provided on a refrigerant line. In the present manner, various types of heaters are separately provided to be used in the integrated heat management system.

However, separate provision of the water-heating heater for increasing the temperature of the battery and the air-heating heater for heating the interior is not efficient in terms of heat management and increases the number of parts. Thus, recently, research for reducing the number of parts while improving an integrated heat management circuit has been continuously conducted.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a compressor apparatus for a vehicle having an integrated configuration of a compressor apparatus compressing refrigerant and a heater heating the refrigerant.

In various aspects of the present disclosure, there is provided a compressor apparatus for a vehicle, the compressor apparatus including: a compression portion configured for compressing refrigerant; and a heating portion provided integrally with the compression portion, including defined in the heating portion an internal space in which the refrigerant discharged from the compression portion flows, and configured to heat and discharge the refrigerant flowing in the internal space.

The compression portion may include a compressor body having defined therein a compression area in which the refrigerant is compressed, the compressor body including an inlet port through which the refrigerant is drawn into the compression area and an outlet port through which the compressed refrigerant is discharged from the compression area. The heating portion may include a heater body integrally mounted on an external surface of the compressor body and having an internal space defined in the heater body and a heating module disposed in the internal space of the heater body to heat the flowing refrigerant while guiding the refrigerant through a flow path.

The heater body may include a housing having one open side, and is mounted on the external surface of the compressor body to cover an area in which the outlet port is provided with the one open side, forming a sealed internal space.

The heating module may include: a guide plate dividing the internal space of the heater body into a plurality of flow path spaces and configured to allow the refrigerant to flow through the plurality of divided flow path spaces; and a heating element provided on the guide plate to heat the flowing refrigerant.

The guide plate may have one or more flow path holes through which the divided flow path spaces fluidically communicate with each other.

The guide plate may include at least one first guide plate dividing the internal space of the heater body in a lateral direction and at least one second guide plate dividing the internal space of the heater body in a vertical direction. one of the divided flow path spaces in the internal space of the heater body fluidically communicates with the outlet port provided in the compressor body, the flow path holes sequentially allow remaining flow path spaces to fluidically communicate, and the outlet port is provided in a rear end portion of a rearmost one of the flow path spaces of the internal space.

The flow path of the refrigerant defined by the guide plate may extend in series from the outlet port in the compressor body to an outlet port in the heater body.

The heating element may be buried in the guide plate or disposed on a surface of the guide plate.

The heating element may be implemented as a hot wire configured to generate heat using electric power applied thereto.

The compressor apparatus may further include a heat insulating cover covering and thermally insulating the heater body.

According to exemplary embodiments of the present disclosure, the compressor apparatus has integrated therewith a configuration for performing the function of a heater. Thus, in provision of an integrated heat management circuit of a vehicle, an effect capable of reducing the number of parts may be expected.

Furthermore, an effect capable of selectively heating refrigerant while compressing the refrigerant using the compressor apparatus may be expected.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view exemplarily illustrating portions of a heat management circuit in which a compressor for a vehicle according to various exemplary embodiments of the present disclosure is used;

FIG. 2 is a perspective view exemplarily illustrating the compressor for a vehicle according to various exemplary embodiments of the present disclosure;

FIG. 3 is an exploded perspective view exemplarily illustrating the compressor for a vehicle according to various exemplary embodiments of the present disclosure;

FIG. 4 is a perspective view exemplarily illustrating a heating module of a compressor for a vehicle according to various exemplary embodiments of the present disclosure; and

FIG. 5 is a cross-sectional view exemplarily illustrating the compressor for a vehicle according to exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments of the present disclosure will be described in more detail with reference to the accompanying drawings. The present disclosure may, however, be embodied in a variety of different forms and may not be construed as limited to the exemplary embodiments set forth herein. Rather, these embodiments are provided so that the present disclosure of the present disclosure will be thorough and complete and will fully convey the scope of the present disclosure to those skilled in the art. Throughout the drawings, the same reference numerals will refer to the same or like parts.

A compressor for a vehicle according to an exemplary embodiment of the present disclosure is an apparatus used in an integrated heat management system performing heat management of the internal space, the battery, and electric components of an eco-friendly vehicle, such as an electric vehicle, integrally. For example, the compressor for a vehicle may be used in a heat pump system realizing cooling and heating by circulating refrigerant.

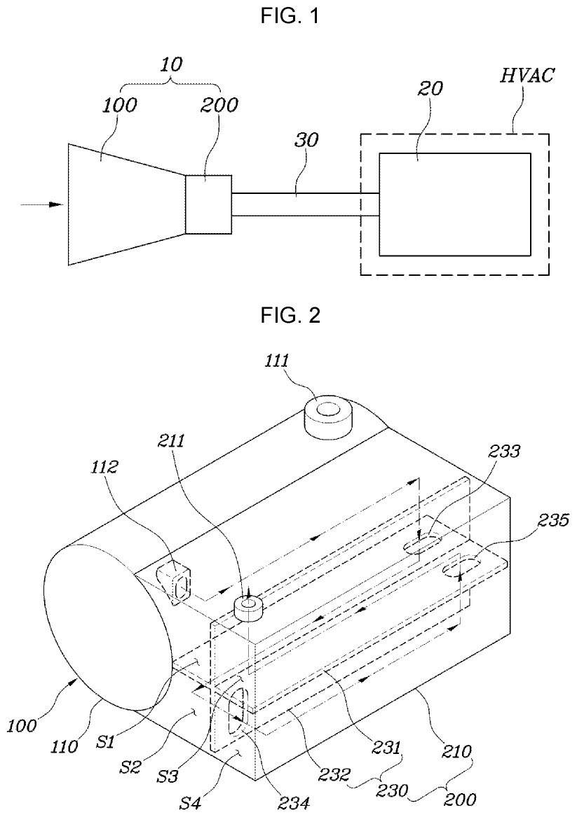

FIG. 1 is a schematic view exemplarily illustrating portions of a heat management circuit in which a compressor for a vehicle according to various exemplary embodiments of the present disclosure is used. When circulating refrigerant is drawn into a compressor 10 according to various exemplary embodiments of the present disclosure, the refrigerant is compressed and heated while passing through the compressor 10 according to an exemplary embodiment of the present disclosure, and then discharged. The refrigerant discharged in the present manner passes through an internal condenser 20 provided to cool or heat the internal space of the vehicle.

The compressor 10 and the internal condenser 20 are connected through a flow path pipe 30 through which the refrigerant flows. Since the refrigerant discharged from the compressor 10 has been heated while in a compressed state, the flow path pipe 30 may be implemented as a metal pipe or a hose for high-temperature and high-pressure applications, and the exterior of the flow path pipe 30 may be covered with an insulating material to prevent heat loss.

The refrigerant discharged from the compressor 10 is not limited to that entering the internal condenser 20, and may enter a variety of components depending on the integrated heat management circuit of the vehicle.

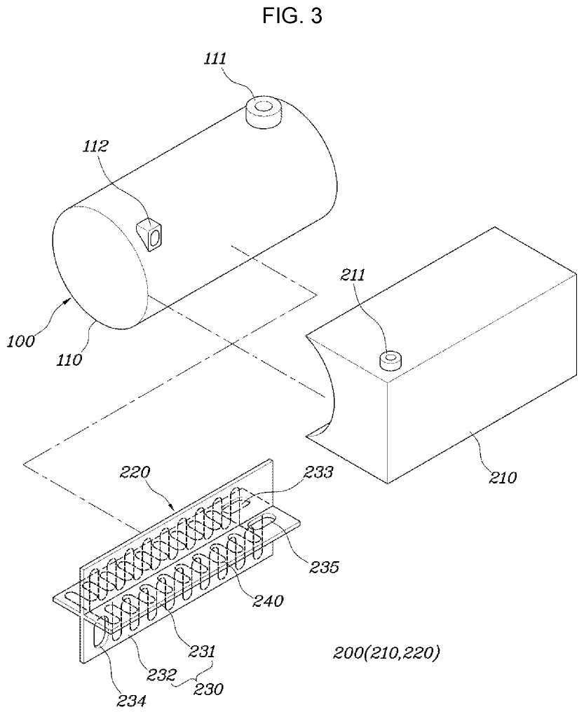

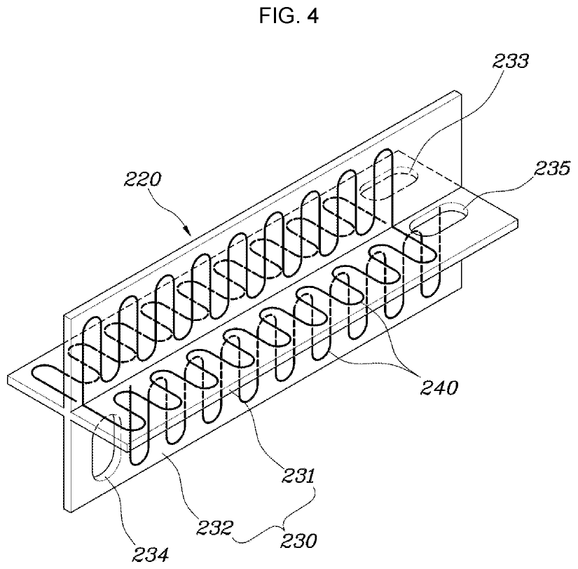

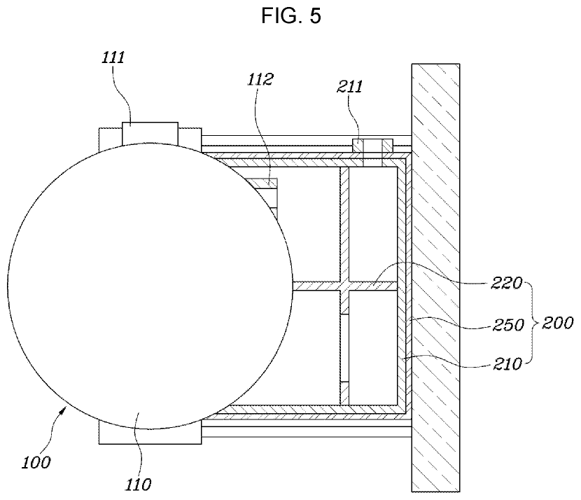

FIG. 2 is a perspective view exemplarily illustrating the compressor for a vehicle according to various exemplary embodiments of the present disclosure, FIG. 3 is an exploded perspective view exemplarily illustrating the compressor for a vehicle according to various exemplary embodiments of the present disclosure, FIG. 4 is a perspective view exemplarily illustrating a heating module of a compressor for a vehicle according to various exemplary embodiments of the present disclosure, and FIG. 5 is a cross-sectional view exemplarily illustrating the compressor for a vehicle according to exemplary embodiments of the present disclosure.

As illustrated in FIG. 2, FIG. 3, FIG. 4 and FIG. 5, the compressor 10 for a vehicle according to exemplary embodiments of the present disclosure includes: a compression portion 100 compressing refrigerant and a heating portion 200 heating refrigerant discharged from the compression portion 100.

The compression portion 100 is a means for compressing refrigerant circulating for cooling and heating, and may be implemented as a compressor used in a heat pump system.

For example, the compression portion 100 may include a compressor body 110 having defined therein a compression area in which refrigerant is compressed. The compressor body 110 includes an inlet port 111 through which the refrigerant is drawn into the compression area and an outlet port 112 through which the compressed refrigerant is discharged from the compression area. Here, the compressor body 110 may be configured to compress the refrigerant by a variety of schemes. In an exemplary embodiment of the present disclosure, the compressor body 110 may have any configuration able to draw in and then compress the refrigerant and discharge the compressed refrigerant.

The heating portion 200 is a means for heating the refrigerant discharged from the compression portion 100, and is provided integrally with the compression portion 100, providing the compressor 10.

The heating portion 200 may be configured to fluidically communicate with the outlet port 112 of the compression portion 100 to heat the compressed refrigerant discharged from the compression portion 100.

For example, the heating portion 200 includes a heater body 210 and a heating module 220 to guide the compressed refrigerant, discharged from the compression portion 100, through a flow path and heat the flowing refrigerant. The heater body 210 is integrally mounted on the external surface of the compressor body 110 and has an internal space defined therein. The heating module 220 is disposed in the internal space of the heater body 210 to heat the flowing refrigerant while guiding the refrigerant through the flow path.

The heater body 210 is configured as a housing having defined therein a space through which the compressed refrigerant flows and one open side, by which the heater body 210 is integrated with the compressor body 110. Here, the shape of the open side corresponds to the shape of the external surface of the compressor body 110. For example, in a case in which the compressor body 110 has the shape of a cylinder, the open side of the heater body 210 may have a round shape.

Thus, the heater body 210 is mounted on the external surface of the compressor body 110 so that an area of the external surface of the compressor body 110, in which the outlet port 112 is provided, is covered with the open side of the heater body 210. Consequently, the open side of the heater body 210 is sealed by the external surface of the compressor body 110, forming a sealed internal space.

Here, the heater body 210 has an outlet port 211 in a predetermined position, the outlet port 211 allowing the refrigerant to be discharged from the sealed internal space therethrough.

The heating module 220 is a means for guiding the refrigerant through the flow path and heating the refrigerant while the refrigerant is flowing, and is provided in the internal space of the heater body 210.

For example, the heating module 220 includes a guide plate 230 and heating elements 240. The guide plate 230 divides the internal space of the heater body 210 into a plurality of flow path spaces S1 to S4, and is configured so that the refrigerant flows through the plurality of divided flow path spaces S1 to S4. The heating elements 240 are provided on the guide plate 230 to heat the flowing refrigerant.

The guide plate 230 may be provided in the internal space of the heater body 210 and configured to provide a sufficient flow path in which the refrigerant may be heated to an intended temperature. Thus, the guide plate 230 may be configured in a variety of shapes configured for extending the flow path of the refrigerant.

For example, the guide plate 230 may include at least one first guide plate 231 and at least one second guide plate 232. The first guide plate 231 divides the internal space of the heater body 210 in the lateral direction to divide the internal space of the heater body 210 into a plurality of flow path spaces. The second guide plate 232 divides the internal space of the heater body 210 in the vertical direction.

As illustrated in FIG. 2 and FIG. 3, in an exemplary embodiment of the present disclosure, a single first guide plate 231 dividing the internal space of the heater body 210 in the lateral direction is provided, and a single second guide plate 232 dividing the internal space of the heater body 210 in the vertical direction is provided. Thus, the internal space of the heater body 210 is divided into the four flow path spaces S1 to S4 such that the cross-section of the guide plate 230 has the shape of a cross.

The first guide plate 231 and the second guide plate 232 of the guide plate 230 may also have a variety of shapes and numbers depending on the shape of the heater body 210, the capacity of the compressor 10, and heating performance of the heating elements 240.

In an exemplary embodiment of the present disclosure, the internal space of the heater body 210 is divided into the four flow path spaces S1 to S4 by the guide plate 230. Thus, to allow the plurality of divided flow path spaces S1 to S4 to fluidically communicate with each other, the guide plate 230 has one or more flow path holes 233, 234, and 235 through which the plurality of divided flow path spaces S1 to S4 fluidically communicate with each other.

For example, at least three flow path holes 233, 234, and 235 may be provided so that the four flow path spaces S1 to S4, divided by the first guide plate 231 and the second guide plate 232, fluidically communicate with each other through the flow path holes 233, 234, and 235.

In an exemplary embodiment of the present disclosure, the refrigerant flow path defined by the guide plate 230 extends in series from the outlet port 112 in the compressor body 110 to the outlet port 211 in the heater body 210 to maintain the fluidity of the refrigerant at a predetermined level while sufficiently utilizing the internal space of the heater body 210 and maintain an intended level of heating efficiency.

In this regard, one of the divided flow path spaces in the internal space of the heater body 210 fluidically communicates with the outlet port 112 provided in the compressor body 110, the flow path holes 233, 234, and 235 sequentially allow remaining flow path spaces to fluidically communicate, and the outlet port 211 is provided in the rear end portion of the rearmost flow path space of the internal space so that the flow path spaces of the internal space of the heater body 210, divided by the first guide plate 231 and the second guide plate 232 in the shape of a cross, are connected in series so that the refrigerant flows in series.

Thus, in the compressor body 110, the compressed refrigerant is discharged from the internal space of the heater body 210 through the outlet port 112, circulates through the internal space of the heater body 210 due to the shape of guide plate 230, i.e., the first guide plate 231, the second guide plate 232, and the three flow path holes 233, 234, and 235, and then is discharged from the compressor 10 through the outlet port 211 provided in the heater body 210.

Described in more detail, as illustrated in FIG. 2 and FIG. 3, in a case in which the internal space of the heater body 210 is divided into the shape of a cross and the four flow path spaces S1 to S4 are provided, the length of each of the flow path spaces S1 to S4 corresponds to the length of the compressor body 110. Here, to clarify the description, the four flow path spaces provided in the internal space of the heater body 210 will be referred to as the first to fourth flow path spaces S1 to S4, respectively, in the following description.

For example, in FIG. 2, a portion of the internal space corresponding to the upper left portion of the internal space of the heater body 210 will be referred to as the first flow path space S1, a portion of the internal space corresponding to the lower left portion of the internal space of the heater body 210 will be referred to as the second flow path space S2, a portion of the internal space corresponding to the lower right portion of the internal space of the heater body 210 will be referred to as the third flow path space S3, and a portion of the internal space corresponding to the upper right portion of the internal space of the heater body 210 will be referred to as the fourth flow path space S4.

Thus, the outlet port 112 of the compressor body 110 is disposed in the front portion of the first flow path space S1, i.e., one of the four flow path spaces S1 to S4. The first flow path hole 233 is provided in the first guide plate 231 in the rear portion of the first flow path space S1, allowing the first flow path space S1 to fluidically communicate with the second flow path space S2.

Furthermore, the flow path hole 234 is provided in the second guide plate 232 in the front portion of the second flow path space S2, allowing the second flow path space S2 to fluidically communicate with the third flow path space S3.

Furthermore, the third flow path hole 235 is provided in the first guide plate 231 in the rear portion of the third flow path space S3, allowing the third flow path space S3 to fluidically communicate with the fourth flow path space S4. Furthermore, the outlet port 211 is provided in the front portion of the fourth flow path space S4 so that the refrigerant is discharged from the heater body 210 through the outlet port 211.

Furthermore, the heating elements 240 are a means provided on the guide plate 230 to heat the refrigerant. Here, the heating elements 240 may be implemented by any method or as any shape configured for directly or indirectly heating the flowing refrigerant.

For example, in an exemplary embodiment of the present disclosure, the heating elements 240 are provided on the guide plate 230, i.e., the first guide plate 231 and the second guide plate 232, as hot wires configured to generate heat using electric power applied thereto. Thus, the heating elements 240 may be determined to generate heat depending on whether or not electric power is applied thereto.

The heating elements 240 may be buried in the guide plate 230, as illustrated in FIG. 3, to prevent from being damaged by the refrigerant and prevent the refrigerant from degrading. Thus, when the heating elements 240 generate heat, the guide plate 230 is heated to heat the refrigerant coming into contact with the guide plate 230.

Because the guide plate 230 needs to be heated along with the heat generation of the heating elements 240, the guide plate 230 may be made of a metal material having high thermal conductivity.

Furthermore, the heating elements 240 are not limited to being buried in the guide plate 230. As illustrated in FIG. 4, the heating elements 240 may be disposed on the surface of the guide plate 230 to directly heat the refrigerant.

Furthermore, as illustrated in FIG. 5, a heat insulating cover 250 may further be provided outside the heater body 210 to cover and thermally insulate the heater body 210 to reduce heat loss of the heated refrigerant.

Here, the heat insulation cover 250 may be implemented using a variety of materials and in a variety of shapes configured for minimizing heat loss of the refrigerant while covering the heater body 210.

In an exemplary embodiment of the present disclosure, the heat insulation cover 250 is configured in a shape corresponding to the external shape of the heater body 210 and in a shape covering the exterior of the heater body 210 while being in close contact with the external surface of the heater body 210.

The operation of the compressor for a vehicle having the above-described configuration, according to various exemplary embodiments of the present disclosure, will be described hereinafter with reference to the drawings.

As illustrated in FIG. 2, the refrigerant drawn into the compressor body 110 through the inlet port 111 is compressed in the compression area, and then discharged through the outlet port 112.

The refrigerant discharged from the outlet port 112 of the compressor body 110 flows from the front portion to the rear portion in the first flow path space S1, and then flows toward the rear portion of the second flow path space S2 through the first flow path hole 233 in the first guide plate 231.

Afterwards, the refrigerant flows toward the front portion of the second flow path space S2, and then flows toward the front portion of the third flow path space S3 through the second flow path hole 234 in the second guide plate 232.

Subsequently, the refrigerant flows toward the rear portion of the third flow path space S3, and then flows toward the rear portion of the fourth flow path space S4 through the third flow path hole 235 in the first guide plate 231.

Thereafter, the refrigerant flows toward the front portion of the fourth flow path space S4, and then is discharged from the heater body 210 through the outlet port 211 in the heater body 210.

Meanwhile, the compressed refrigerant discharged through the outlet port 112 is heated by the heat generation of the heating elements 240 provided on the guide plate 230 while sequentially flowing through the first flow path space S1, the second flow path space S2, the third flow path space S3, and the fourth flow path space S4.

Furthermore, as the heating elements 240 generate heat using electric power applied thereto, the guide plate 230 is also heated. Consequently, the refrigerant flowing inside the heater body 210 is directly or indirectly heated through contact with the guide plate 230 or by the heated heating elements 240 and the heated guide plate 230 while passing through the surroundings of the guide plate 230.

When the refrigerant compressed and heated as above is discharged, the refrigerant enters the internal condenser 20 through the flow path pipe 30 illustrated in FIG. 1 and dissipates heat through heat exchange with the air introduced into the interior of the vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A compressor apparatus for a vehicle, the compressor apparatus comprising:
a compression portion configured for compressing refrigerant; and
a heating portion provided integrally with the compression portion and having an internal space in which the refrigerant discharged from the compression portion flows,
wherein the heating portion is configured to heat and discharge the refrigerant flowing in the internal space.

2. The compressor apparatus of claim 1,
wherein the compression portion includes a compressor body including a compression area in which the refrigerant is compressed, wherein the compressor body further includes an inlet port through which the refrigerant is drawn into the compression area and an outlet port through which the compressed refrigerant is discharged from the compression area, and
wherein the heating portion includes:
a heater body integrally mounted on an external surface of the compressor body and having an internal space defined in the heater body; and
a heating module disposed in the internal space of the heater body to heat the flowing refrigerant while guiding the refrigerant through a flow path.

3. The compressor apparatus of claim 2, wherein the heater body includes a housing having one open side, and is mounted on the external surface of the compressor body to cover an area in which the outlet port is provided with the one open side, for forming a sealed internal space.

4. The compressor apparatus of claim 2, wherein the heating module includes:
a guide plate dividing the internal space of the heater body into a plurality of flow path spaces and configured to allow the refrigerant to flow through the plurality of divided flow path spaces; and
a heating element provided on the guide plate to heat the flowing refrigerant.

5. The compressor apparatus of claim 4, wherein the guide plate has one or more flow path holes through which the divided flow path spaces fluidically communicate with each other.

6. The compressor apparatus of claim 5,
wherein the guide plate includes at least one first guide plate dividing the internal space of the heater body in a lateral direction and at least one second guide plate dividing the internal space of the heater body in a vertical direction, and
wherein one of the divided flow path spaces in the internal space of the heater body fluidically communicates with the outlet port provided in the compressor body, the flow path holes sequentially allow remaining flow path spaces to fluidically communicate, and the outlet port is provided in a rear end portion of a rearmost one of the flow path spaces of the internal space.

7. The compressor apparatus of claim 6, wherein the flow path of the refrigerant defined by the guide plate extends in series from the outlet port in the compressor body to an outlet port in the heater body.

8. The compressor apparatus of claim 4, wherein the heating element is buried in the guide plate or disposed on a surface of the guide plate.

9. The compressor apparatus of claim 4, wherein the heating element includes a hot wire configured to generate heat using electric power applied thereto.

10. The compressor apparatus of claim 2, further including a heat insulating cover covering and thermally insulating the heater body.

11. A heat management circuit comprising:
a compressor apparatus including:
a compression portion configured for compressing refrigerant; and
a heating portion provided integrally with the compression portion and having an internal space in which the refrigerant discharged from the compression portion flows, wherein the heating portion is configured to heat and discharge the refrigerant flowing in the internal space; and
an internal condenser connected to the heating portion of the compressor apparatus,
wherein when the refrigerant is drawn into the compression portion of the compressor apparatus, the refrigerant is compressed and heated while passing through the compression portion and the heating portion of the compressor apparatus and then discharged into the internal condenser provided to cool or heat an internal space of a vehicle.

12. The heat management circuit of claim 11,
wherein the compression portion includes a compressor body including a compression area in which the refrigerant is compressed, wherein the compressor body further includes an inlet port through which the refrigerant is drawn into the compression area and an outlet port through which the compressed refrigerant is discharged from the compression area, and
wherein the heating portion includes:
a heater body integrally mounted on an external surface of the compressor body and having an internal space defined in the heater body; and
a heating module disposed in the internal space of the heater body to heat the flowing refrigerant while guiding the refrigerant through a flow path.

13. The heat management circuit of claim 12, wherein the heater body includes a housing having one open side, and is mounted on the external surface of the compressor body to cover an area in which the outlet port is provided with the one open side, for forming a sealed internal space.

14. The heat management circuit of claim 12, wherein the heating module includes:
a guide plate dividing the internal space of the heater body into a plurality of flow path spaces and configured to allow the refrigerant to flow through the plurality of divided flow path spaces; and
a heating element provided on the guide plate to heat the flowing refrigerant.

15. The heat management circuit of claim 14, wherein the guide plate has one or more flow path holes through which the divided flow path spaces fluidically communicate with each other.

16. The heat management circuit of claim 15,
wherein the guide plate includes at least one first guide plate dividing the internal space of the heater body in a lateral direction and at least one second guide plate dividing the internal space of the heater body in a vertical direction, and
wherein one of the divided flow path spaces in the internal space of the heater body fluidically communicates with the outlet port provided in the compressor body, the flow path holes sequentially allow remaining flow path spaces to fluidically communicate, and the outlet port is provided in a rear end portion of a rearmost one of the flow path spaces of the internal space.

17. The heat management circuit of claim 16, wherein the flow path of the refrigerant defined by the guide plate extends in series from the outlet port in the compressor body to an outlet port in the heater body.

18. The heat management circuit of claim 14, wherein the heating element is buried in the guide plate or disposed on a surface of the guide plate.

19. The heat management circuit of claim 14, wherein the heating element includes a hot wire configured to generate heat using electric power applied thereto.

20. The heat management circuit of claim 12, further including a heat insulating cover covering and thermally insulating the heater body.
